(19) United States
(12) Patent Application Publication
(10) Pub. No.: US 2005/0027621 A1
(43) Pub. Date: Feb. 3, 2005

(54) Methods and apparatus for retail inventory budget optimization and gross profit maximization

(76) Inventor: Vishwamitra S. Ramakrishnan, Belmont, MA (US)

Correspondence Address: NUTTER MCCLENNEN & FISH LLP, WORLD TRADE CENTER WEST, 155 SEAPORT BOULEVARD, BOSTON, MA, 02210-2604, US

(21) Appl. No.: 10/861,772

(22) Filed: Jun. 4, 2004

Related U.S. Application Data
(60) Provisional application No. 60/475,875, filed on Jun. 4, 2003.

(51) Int. Cl. G06F 17/60

(52) U.S. Cl. 705/28

(57) ABSTRACT

The invention provides methods and apparatus for determining optimum inventory allocations across retail stores and departments. According to one aspect of the invention, such methods include inputting an historical return on investment for each of plural merchandise departments and/or stores (collectively, “departments”) in a retail enterprise. This return on investment can be, for example, a gross margin return on investment (GMROI) that is a function of the inventory allocated to each respective department in each of one or more prior periods, e.g., selling seasons, as well as the financial return achieved by that department based on that inventory. The method further includes determining inter-departmental (or inter-store) risks in the historical returns on investment (e.g., GMROI's). This can be determined, for example, as a function of the covariance between the historical GMROI's of each pair of departments in the plurality of departments. Still further, the method includes determining an optimal allocation of inventory budget to each of the departments for a current or future time period, e.g., a current or future selling season. That optimization is determined by maximizing the total return (e.g., gross margin dollars, if GMROI is used as the return on investment measure) for those departments, as a whole, as a function of one or more constraints—at least one of which is a tolerance of risk in the return on investment (e.g., GMROI) for the plural departments, as a whole. That optimum allocation is displayed, according to the method, in a report to an general merchandise manager or other person. Alternatively, or in addition, the optimum allocation is used to fund accounts used by the departments to acquire inventory.

### BACKGROUND

This application claims the benefit of priority of U.S. Provisional Patent Application Ser. No. 60/475,875, filed Jun. 4, 2003, entitled “Applying Portfolio Management Ideas to Merchandising,” the teachings of which are incorporated herein by reference.

The invention pertains to digital data processing and, more particularly, to determining an optimum allocation of inventory among retail stores or departments. The invention has application, by way of non-limiting example, in the fashion apparel trade, the department store trade, and other business that retail a variety of merchandises in several departments and/or several geographic locations.

Retailing can be an unpredictable business. This is especially true where fashion, fads or other volatile external factors drive purchasing decisions. Thus, for example, an article of clothing that is in vogue this month among teens may fall out of favor next month, only to become popular four months later among thirty-somethings.

To compensate for this, chain stores and other large retailers typically employ general merchandise managers (GMMs). These individuals are often responsible for setting overall merchandising strategy, ensuring that pricing, promotions and marketing improve the bottom line, e.g., in the face of changes in demand. GMMs are also responsible for allocating inventory budgets for the departments so that stock available throughout the buying season will meet but, preferably, not exceed demand.

To this end, typically a GMM (or CFO) is given an overall inventory budget. He is charged with maximizing the return on that budget while honoring constraints such as the minimum inventory investment needed for each department, e.g., due to traffic considerations, the extent of square footage that is available, and so on. Often the departmental allocations are based on the prior year's figures, modified to accommodate any inventory overruns or shortages that occurred, changes in pricing, and so forth. To the extent that GMMs take risk into account in any explicit manner, it is based on a gut feel about how each individual department is expected to fare in the upcoming season.

An object of this invention is to provide improved methods of digital data processing and, particularly, for example, improved methods for determining optimum allocations of inventory among retail departments and/or geographic locations.

Yet another object is to provide such methods as can be implemented using historical retail data and conventional departmental constraints.

Still another object is to provide such methods as are applicable in a range of retailing environments, including fashion apparel retail.

### SUMMARY

The aforementioned are among the objects attained by the invention which provides methods and apparatus for determining optimum inventory budget allocations across retail stores and departments. Those allocations can be used, for example, to generate reports (e.g., for use by a general merchandise manager or other personnel) and/or for funding inventory acquisition accounts.

According to one aspect of the invention, such methods include inputting an historical return on investment for each of plural merchandise departments and/or stores (collectively, “departments”) in a retail enterprise. This return on investment can be, for example, a gross margin return on investment (GMROI) that is a function of the inventory allocated to each respective department in each of one or more prior periods, e.g., selling seasons, as well as the financial return achieved by that department based on that inventory.

The method further includes determining inter-departmental (or inter-store) risks in the historical returns on investment (e.g., GMROI's). This can be determined, for example, as a function of the covariance between the historical GMROI's of each pair of departments in the plurality of departments.

Still further, the method includes determining an optimal allocation of inventory budget to each of the departments for a current or future time period, e.g., a current or future selling season. That optimization is determined by maximizing the total return (e.g., gross margin dollars, if GMROI is used as the return on investment measure) for those departments, as a whole, as a function of one or more constraints—at least one of which is a tolerance of risk in the return on investment (e.g., GMROI) for the plural departments, as a whole. That optimum allocation is displayed, according to the method, in a report to an general merchandise manager or other person. Alternatively, or in addition, the allocation can be used (e.g., via an accounting and/or banking interface module) to fund accounts from which the departments acquire inventory.

Related aspects of the invention include methods as described above in which the optimal allocation is determined by executing an optimization tool, such as the Solver program in Microsoft Excel, on a digital data processor.

Further related aspects of the invention include methods as described in which the risk in a GMROI for the plural departments, as a whole, is determined as a function of (i) a candidate allocation of inventory budgets to each of the departments, and (ii) covariance between historical GMROI's of each pair of departments in the plurality.

Other aspects of the invention include methods as described above in which the optimal allocation is determined as a function of constraints that include, not only tolerance of risk in return on investment (e.g., GMROI) for the plural departments, as a whole, but also one or more of the following: (i) a maximum budget for those plural departments, as a whole, (ii) a minimum allocation of inventory budget to one or more of the departments, and (iii) a maximum space required for inventory.

Yet still other aspects of the invention include methods of optimizing allocation of inventory budgets as described above in which at least the optimization step is executed on a digital data processor.

These and other aspects of the invention are evident in the drawings and in the description that follows.

### BRIEF DESCRIPTION OF THE DRAWINGS

A more complete understanding of the invention may be attained by reference to the drawings, in which:

FIG. 1 depicts a digital data processing system of the type in which the invention is embodied;

FIG. 2 is a flowchart depicting steps performed in an optimization system according to one practice of the invention;

FIG. 3 depicts a table of GMROIs used as an input to a system according to the invention;

FIG. 4 depicts a table of covariances generated during execution of a system according to one practice of the invention; and

FIG. 5 depicts a report produced by a system according to the invention.

### DETAILED DESCRIPTION OF INVENTION

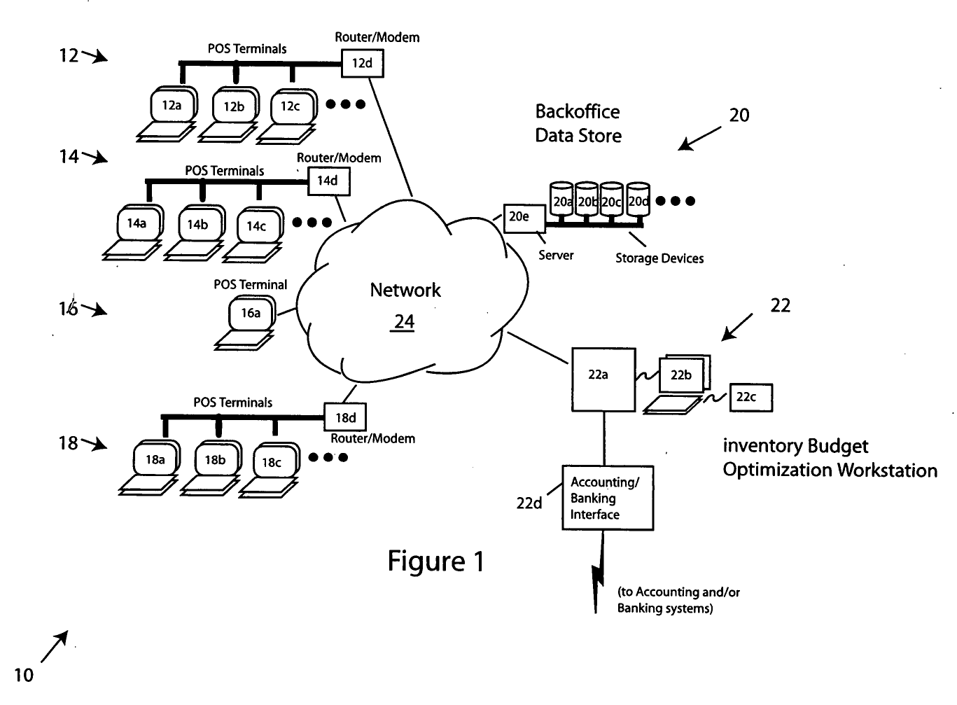

FIG. 1 depicts an environment in which the invention is practiced. While this may be a retailing enterprise of international, national, local (or other) scale, in the illustrated embodiment, the environment is a retail store 10 comprising (among other things) retail departments 12-18, “back office” data store 20, and inventory budget optimization workstation 22. These are interconnected for communication via a local area network 24, as illustrated.

Departments 12-18 represent conventional (or non-conventional) retail departments such as, by way of non-limiting example, apparel, housewares, jewelry, furniture, beauty, electronics, and so forth. Typically, these departments have separate inventories and inventory budgets. Moreover, the departments typically experience different monetary returns from sales, lending or leasing (collectively, “sales”) of the respective inventories, e.g., on account of differences in costs, pricing and/or demand.

Although the text that follows largely addresses inventory budget allocation among merchandising departments within a single-store “enterprise,” the invention is equally applicable to inventory budget allocation among stores (or across departments) within larger retail enterprise, e.g., of international, national or other scope. As above, these stores have separate inventories and inventory budgets. And, as above, the stores typically experience different monetary returns from sales of their respective inventories. In such environments, “departments” 12-18 represent those stores (or other retail outlets) and/or some or all of their constituent departments. In this regard, the term “retail sites” can be substituted for the term “departments” in this patent specification and the claims that follow. Likewise, the term “inter-site” can be substituted for the term “inter-departmental,” and so forth.

In the drawing, each department is represented by one or more interconnected point of sale (POS) terminals 12a-18c. These provide for inventory tracking and management, as well as for collection of monies from retail patrons at the time of sale. Though POS terminals are used for these purposes in the illustrated embodiment, it will be appreciated that in other embodiments these functions may be exercised by other mechanisms known in the art, automated or otherwise.

Back office data store 20 represents a repository of sales information from departments 12-18, as well as information regarding their inventory budgets, during prior time periods, e.g., fiscal years, selling seasons, and the like. This may be part of a general back office management function, e.g., that additionally includes overall corporate financial tracking and management, or otherwise. In the illustrated embodiment, the store 20 comprises storage devices 20a-20d, which are coupled to network 24, via server and/or database management system 20e. Information regarding sales from inventory is communicated from the POS terminals in each of the departments to store 20 via router/modems 12d, 14d, 16d, 18d and network 24, though in other embodiments that information may be communicated by other means. Of course, in some embodiments, data store 20 may be contained in or obtained from other, multiple and/or distributed sources.

Inventory budget optimization workstation 22 comprises a personal computer, workstation, mainframe or other digital data processing system of the type commonly available in the marketplace, as programmed in accord with the teachings hereof for determining optimum inventory allocations and reporting those allocations and/or funding inventory acquisition accounts. The workstation 22 comprises processor section 22a (comprising a central processing unit, dynamic storage, input/output control, and the like), a monitor, keyboard and other user input/output devices 22b, and printers or other output devices 22c, networked, or otherwise—again, all of the type commercially available in the marketplace.

The invention is based in part on the discovery that retail merchandise inventory investment decisions can be made by applying the otherwise unrelated theory of financial portfolio optimization. This capitalizes on a similarity not appreciated by artisans in either the retail merchandise inventory investment field or the portfolio management field. The inventor hereof has realized that problems in these two otherwise disparate fields have some commonality and that workstation 22—or other digital data processing apparatus operating in accord with the invention—can be adapted to optimize retail merchandise inventory investment decisions (e.g., for reporting purposes and/or purposes of funding inventory accounts) for departments 12-18 using ideas from the theory of portfolio optimization.

Most notably, as discussed in detail below, workstation 22 models the merchandise inventory investment decision problem in a manner that reflects, not just return on inventory “investments” by each of departments 12-18, but also the risk associated with those “investments.” By optimizing inventory investment decisions among all departments based on such a model, general merchandise mangers (GMMs), CFOs or other retail decision-makers (collectively, “general merchandise managers” or “GMMs”), can be made cognizant of and given the ability to manage the risk associated with their inventory allocation decisions, while maximizing their return on investment.

At the start of each planning period, the GMM is given a budget that has to be allocated among multiple departments. He is charged with maximizing the return on the budget while honoring constraints such as the minimum inventory investment needed for each department, e.g., due to traffic considerations, the extent of square footage that is available, and so on.

Comparing the considerations made by a GMM with those made by a conventional investment portfolio manager, it is clear that retail decision-makers don't think about risk in an explicit way, certainly, not in a quantitative way and, still more certainly, not in a quantitative way that takes into account how risks associated with department-level buying decisions add up to total risk for the overall retail inventory “investment.” Rather, prior art retail decision-makers think about risk in an ill-defined, gut feel sort of way. This qualitative assessment is usually at the department level, not the overall store or enterprise level.

However, the inventor has realized that, given nature of retailing and especially, for example, the fickle nature of certain of its sectors (such as fashion apparel), a quantitative assessment of risk associated with inventory investments, at both departmental and store/enterprise levels, can facilitate optimizing allocation of inventory budgets.

To this end, analogizing to the financial world, the risk of allocating budgets to (or “investment” in) the inventory of a single retail department can be defined as the standard deviation of that department's percentage returns over time. Here, “return” is defined as the monetary recoupment from sales of the inventory by that department. That return is referred to below as “general merchandise return on investment” or “GMROI.” It will be appreciated that the GMROI metric described below is merely one way to measure “return on investment.” Those skilled in the art will appreciate that other metrics for return on investment may be used instead or in addition.

If the quarterly percentage return (GMROI) of, say, the Jewelry department for the past three years has been 80% every quarter, then the risk associated with that department is zero (since the returns are constant). On the other hand, if the quarterly returns are 98%, 64%, 142%, 153%, 136%, 101%, 111%, 147%, 72%, 85%, 130%, and 106%, then the mean return is 112% and the risk (i.e., standard deviation) is 81%. What this means is that roughly two-thirds of the time, the quarterly return of Jewelry department will be within 81 % of the average return of 112%. More simply put, a department with fairly steady GMROI will have a lower GMROI risk compared to a department with high GMROI one year and terrible GMROI the next year.

Moving on to the calculation of risk of an inventory budget as a whole., i.e., the risk associated with multiple retail departments in a store or enterprise, inter-departmental covariance comes into play. This is a quantification of the notion that overall risk can be reduced by diversification—or, analogizing (again) to the financial world, that the total risk of an entire stock portfolio is less than the sum of the risks of the individual stocks.

The inventor has discovered that using pair-wise covariances is one way to calculate the risk of the retail inventory budget as a whole. If a certain pair of departments has a highly positive covariance, it means that historically their GMROIs tend to sink or swim together. If a department pair has a highly negative covariance, then when one does well, the other tends to do badly and vice-versa. Using these pair-wise historical GMROI covariances, the illustrated embodiment determines the GMROI risk of the retail inventory budget as a whole, i.e., across all departments.

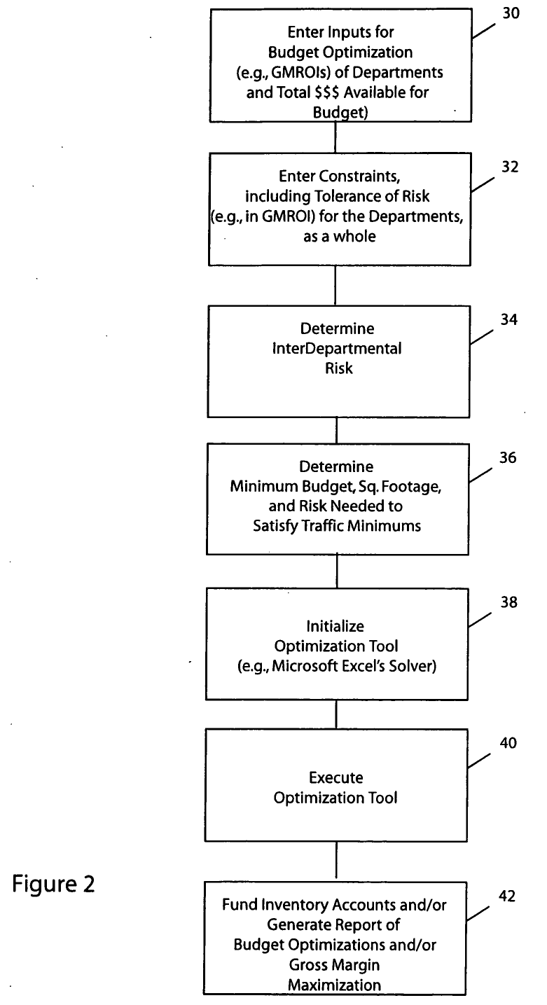

FIG. 2 is a flowchart showing steps executed by workstation 22 in optimizing the expected return of a portfolio of merchandise inventory investments—and, thereby, optimizing allocation of inventory budgets—a current or future sales period, taking GMROI risk and other constraints of the retailer into consideration.

In step 30, the workstation accepts inputs for the budget optimization. These can be input by a user, operating keyboard 22b, loaded from a file on store 20, downloaded or obtained directly from the departments 12-18, or otherwise. In the illustrated embodiment, these include the GMROIs of the departments (for which budget optimization is being performed) for the prior planning periods; the total available budget for inventory across all departments for the current (or future) sales period (for which the optimization is being performed); and the average space intensity (i.e., square footage needed for every $1000 of inventory) for each retail department.

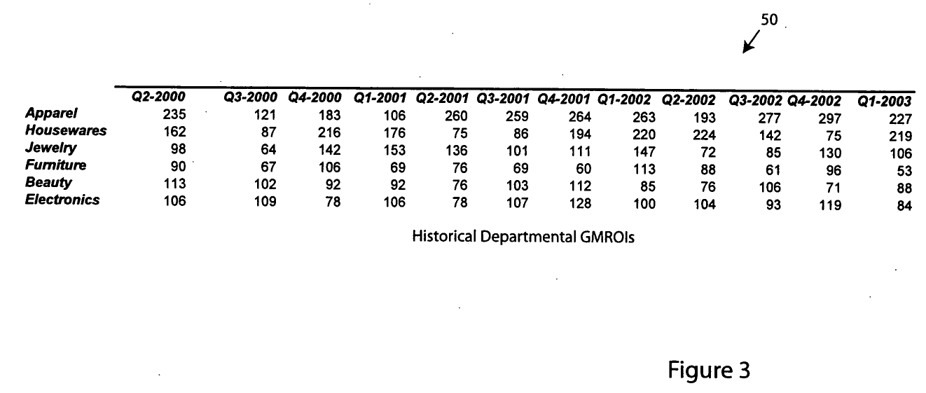

By way of example, the departmental GMROIs for prior periods could be the prior twelve quarterly GMROI for each department, as indicated in the table 50 in FIG. 3. Of course, GMROIs for epochs other than quarters could be used, as could numbers of those epochs be other than twelve (though, for purposes of calculation, it is preferable to have the same number of epochs for each of the departments). And, of course, it will be appreciated that the specific departments identified in the table, and used throughout this disclosure, are merely examples.

In step 32, the workstation accepts constraints used in determining the budget optimization. Typically, these are input by a user, operating keyboard 22b, though the constraints may also be loaded from a file on store 20, downloaded or obtained directly from the departments 12-18, or otherwise. In the illustrated embodiment, the constraints include the tolerance of risk in the GMROI for the departments as a whole, i.e., the risk the GMM is willing to accept on investment of the entire budget amount across all of the retail departments 12-18. The constraints may also include the minimum inventory budget for each department (e.g., the minimum investment in inventory based on traffic considerations or otherwise); and, total available square footage for retailing. Other embodiments may utilize more or less constraints.

In step 34, the workstation determines historical GMROI covariances for each pair of departments as a means of determining interdepartmental risk. Such covariances can be determined in any manner known in the art, though, in the illustrated embodiment, they are computed using the relation:

$$Cov ( X , Y ) = \frac{1}{n} {\sum }_{1}^{n} ( {x}_{i} - {μ}_{x} ) ( {y}_{i} - {μ}_{y} )$$

where,
Cov(X,Y) is the covariance between historical GMOIs for the pair of retail departments X and Y;
n is the number of prior historical GMROIs provided for each of the departments X and Y;
μₓ and μ_{y} are the means GMROIs of historical GMROIs provided for each of departments X and Y

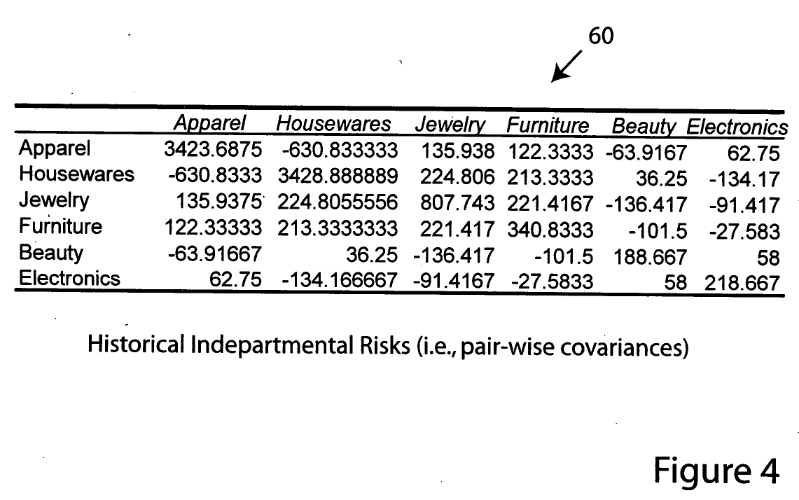

FIG. 4 is a table 60 of interdepartmental risks determined from the values in table 50 in accord with the above, i.e., table 60 is a table of pair-wise covariances.

In step 36, the workstation 22 determines the minimum overall budget, minimum retail square footage, and minimum risk necessary to satisfy the department traffic minimums. In the illustrated embodiment, the minimum overall budget in this regard is the total sum of the minimum investments in inventory for the departments based on traffic considerations. Likewise, the minimum retail square footage is the total sum of the products, for each department, of that department's minimum investment based on traffic considerations and that department's average space intensity. To determine the risk needed to satisfy the department traffic minimums, the workstation 22 of the illustrated embodiment performs a matrix multiplication of (i) an array containing the minimum investments in inventory for the departments, and (ii) the pair-wise covariance matrix represented by table 60. The resulting matrix is multiplied by a transpose of the array of minimum investments. The workstation 22 then takes the square root of the resulting value to yield a risk needed to satisfy the department traffic minimums. Those skilled in the art will appreciate that the minimum overall budget, retail square footage, and risk needed to satisfy the department traffic minimums may be determined in other ways.

In step 38, the workstation 22 initializes a general-purpose optimization tool that can solve quadratic programming problems here, the Solver program that is part of Microsoft Excel, in order to determine the optimum allocation of the total available budget among the plural departments while honoring the constraints. Those skilled in the art will appreciate that other optimization tools can be used instead (or in addition) in order to determine the maximization described below. However, in an embodiment in which the workstation 22 executes the Solver tool within an Excel spreadsheet to make that determination, this entails identifying the following:
A cell defining the metric to maximized by the Solver (or other optimization tool). In the illustrated embodiment, that cell defines an expected gross-margin based on the total sum of the products, for each department, of that department's average historical GMROI and that department's candidate budget allocation (i.e., the allocation determined for that department by Solver during its execution in step 40).
An array of cells defining the departments' respective candidate budget allocations.

It is this array, as alluded to above, that is manipulated by Solver during its execution in step 40. This array is referred to below as the Decision Vector or dv.
A cell defining the total investment in inventory for each set of candidate budget allocations made by Solver. In the illustrated embodiment, it defines the investment as the sum of the candidate budget allocations, i.e., a sum of the values in vector dv. It is used in defining a constraint to maximization of the gross margin by Solver, specifically, a constraint that limits the summed amount to being less than or equal to the total available budget input in step 30.
A cell defining the total retail space required for each set of candidate budget allocations made by Solver. In the illustrated embodiment, it defines that space as the total sum of the products, for each department, of that department's candidate budget allocation and that department's average space intensity input in step 30. That cell is used in defining a constraint to maximization of the gross margin by Solver, specifically, a constraint that limits the total sum to being less than or equal to the total available square footage input in step 32.
A cell defining the total risk on investment for the departments, as a whole, based on each set of candidate budget allocations made by Solver. In the illustrated embodiment, it defines that risk in a calculation that entails: (i) performing a matrix multiplication of the array dv and the matrix represented by Table 60, (ii) multiplying the resulting matrix by the transpose of dv, (iii) taking the square root of the result of step (ii). That amount represented in that cell is used in defining a constraint to maximization of the gross margin by Solver, specifically, a constraint that limits that amount to being less than or equal to the tolerance of risk in the GMROI for the departments, as a whole, entered in step 32.

As part of step 38, the initialization also includes defining a constraint to maximization of the gross margin by Solver to insure that any of the specific departmental candidate budget allocations exceed the minimum inventory budget for each department entered in step 32.

In step 40, the optimization tool is executed in order to maximize gross margin in view of the constraints defined in step 38. Assuming a valid solution set exists, this results in an estimation of a maximum gross margin that can be attained for the departments, as a whole, given the defined constraints. At the same time, it results in the set of candidate budget allocations that achieve that maximum gross margin.

In step 42, this information can be output in a report for use by the GMM, CFO or other decision maker in determining budget allocations for the individual departments in the current or upcoming period. It can also be used to report estimated gross margins to be attained from that allocation. Alternatively, or in addition, the set of candidate budget allocations associated with the maximum gross margin drives an accounting and/or banking interface module 22d—shown in FIG. 1 coupled to workstation 22, by way of non-limiting example—that automatically or semi-automatically funds (e.g., via e-commerce, electronic or other communications with accounting and/or banking systems, as indicated in the drawing). actual or virtual bank accounts from which the respective departments draw for purposes of inventory acquisition.

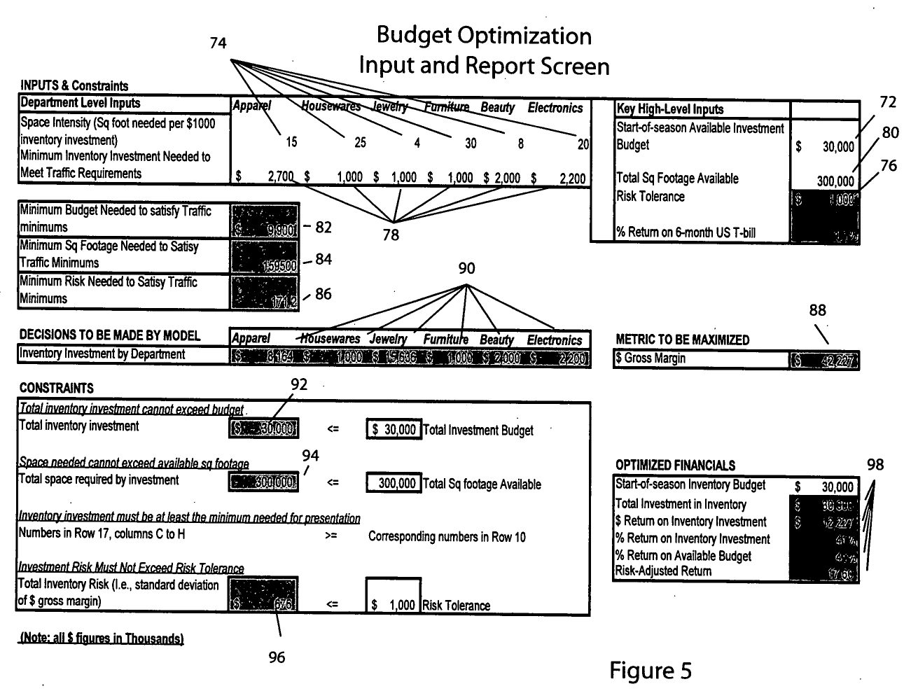

Turning to FIG. 5, there is shown a report of the type generated in step 42 combining the information determined in step 40, as well as the inputs and constraints used in that determination and discussed above.

Referring to that figure, inputs made in Step 30 are denoted by cells 72 (total available budget for inventory across all departments for the current (or future) sales period) and 74 (average space intensity for each retail department). GMROIs of the departments for the prior planning periods are entered via another screen (not shown) or directly from a file, or otherwise, as discussed above. Likewise, constraints entered in Step 32 are denoted by cells 76 (tolerance of risk in the GMROI for the departments as a whole); 78 (minimum inventory budget for each department); and 80 (total available square footage for retailing).

FIG. 5 additionally shows the results of determinations made in step 36. These are denoted by cells 82-86, displaying the minimum overall budget, retail square footage, and risk needed to satisfy the department traffic minimums, respectively. Likewise, it identifies cells utilized in connection with step 38, namely, 88 (cell defining gross margin metric to be maximized ); 90 (the array of cells, dv, defining the departments' respective candidate budget allocations); 92 (cell defining the total investment in inventory for each set of candidate budget allocations); 94 (cell defining the total retail space required for each set of candidate budget allocations made); and 96 (cell defining the total risk on investment for the departments, as a whole, based on each set of candidate budget allocations).

An additional set of optimized financials, based on the foregoing, are shown in cells 98. The last of those figures, labelled Risk-Adjusted Return, equates with the so-called Sharpe Ratio used in financial portfolio management.

Those skilled in the art will appreciate that FIG. 5 represents only one of many reports that can be produced with the figures generated in Step 40. In addition, a suitably equipped workstation 22 could utilize the optimum budget allocations determined in that step to update store/enterprise records, e.g., of the type maintained in store 20.

Described above are methods meeting the aforementioned objects. It will be appreciated that these are only some examples of the invention and that embodiments incorporating modifications thereto fall within the scope of the invention. Thus, for example, it will be appreciated that one or more of the steps described above can be performed other than by a digital data processor. Moreover, it will be appreciated that systems operating according to the invention can be used to optimize budgets for multiple planning periods extending into the store/enterprise future.

1. A method of optimizing allocation of inventory budgets to each of plural merchandise departments and/or stores in a retail enterprise, the method comprising
A. inputting a historical return on investment by each of the plural departments and/or stores (collectively, “departments”) in a retail enterprise, individually,
B. determining inter-departmental risks in the historical returns on investment for the plural departments,
C. determining an optimal allocation of inventory budget to at least one of the plural departments for a current or future time period by maximizing total return on investment for those departments, as a whole, where such maximization is a function of one or more constraints, at least one of which is a tolerance of risk in the return on investment for the plural departments, as a whole,
D. utilizing the optimum allocation determined in step (C) by any of (i) displaying that optimum allocation in a report to an general merchandise manager or other person, and (ii) funding one or more accounts for use by the departments in acquiring inventory.

2. The method of claim 1, comprising executing step (C) on a digital data processor.

3. The method of claim 2, wherein the maximizing step of step (C) comprises executing an optimization tool on the digital data processor.

4. The method of claim 1, wherein step (A) comprises inputting, as the historical return on investment by each of the plural departments, an historical gross margin return on investment (GMROI) of each of the plural departments, where the historical GMROI of each department is determined as function of (i) the inventory allocated to that department in each of one or more prior periods, and (ii) the gross margin earned by that department.

5. The method of claim 4, wherein step (B) comprises determining the inter-departmental risk in the historical returns on investment for the plural departments as a function of covariance between the historical GMROI's of each pair of departments in that plurality.

6. The method of claim 4, wherein step (C) comprises determining a risk in GMROI for the plural departments, as a whole.

7. The method of claim 4, wherein step (C) comprises determining the risk in the GMROI plural departments, as a whole, as a function of (i) a candidate allocation of inventory budgets to those departments and (ii) covariance between historical GMROI's of each pair of departments in that plurality.

8. The method of claim 4, wherein step (C) includes maximizing a gross margin for the plural departments, as a whole, in view of constraints on at least one of (i) a maximum budget for those plural departments, as a whole, (ii) a minimum allocation of inventory budget to one or more of the departments, and (iii) a maximum space required for inventory.

9. The method of claim 1, wherein step (C) includes maximizing a rate of return for the plural departments, as a whole, in view of constraints on at least one of (i) a maximum budget for those plural departments, as a whole, (ii) a minimum allocation of inventory budget to one or more of the departments, and (iii) a maximum space required for inventory.

10. In a method of optimizing allocation of inventory budgets to each of a plural merchandise departments or stores in a retail enterprise that sell from inventory, the improvement comprising executing on a digital data processor the steps of
A. determining a covariance between historical returns on investment of each pair of departments and/or stores (collectively, “departments”) in a retail enterprise in the plural departments,
B. determining an optimal allocation of inventory budgets to each of the plural departments by maximizing a return on investment for those departments, as a whole, in view of one or more constraints, at least one of which is a tolerance of risk in return on investment for the plural departments, as a whole, and
C. utilizing the optimum allocation determined in step (B) by any of (i) displaying that optimum allocation in a report to an general merchandise manager or other person, and (ii) funding one or more accounts for use by the departments in acquiring inventory.

11. In the method of claim 10, the further improvement wherein step (B) comprises determining the risk in return on investment for the plural departments, as a whole, as a function of (i) a candidate allocation of inventory budgets and (ii) the covariance between historical returns on investment of each pair of departments in the plural departments.

12. In the method of claim 11, the further improvement comprising executing steps (A)-(C) on a digital data processor.

13. In the method of claim 11, the further improvement wherein step (A) comprises determining, as the covariance between historical returns on investment of each pair of departments in the plural departments, a covariance between historical gross margin returns on investment (GMROI) of each pair of departments in the plural departments, where the historical GMROI of each department is determined as function of (i) the inventory allocated to that department in each of one or more prior periods, and (ii) the gross margin earned by that department

14. In the method of claim 13, the further improvement, wherein step (B) comprises determining the risk in return on investment for the plural departments as a whole as a function of (i) a candidate allocation of inventory budgets and (ii) the covariance between historical GMROI's of each pair of departments in the plural departments.

15. In the method of claim 10, the further improvement wherein the maximizing step of step (B) comprises executing an optimization tool on the digital data processor.

16. In the method of claim 10, the further improvement wherein step (B) includes maximizing the return on investment for the plural departments, as a whole, in view of constraints on at least one of (i) a maximum budget for the plurality of departments, as a whole, (ii) a minimum allocation of inventory budget to one or more of the departments, and (iii) a maximum space required for inventory.
